(19) United States
(12) Patent Application Publication
(10) Pub. No.: US 2003/0133643 A1
(43) Pub. Date: Jul. 17, 2003

(54) Optical switch

(75) Inventors: Hyun Ho Oh, Anyang (KR); Jong Uk Bu, Seongnam (KR); Don Hee Lee, Anyang (KR)

Correspondence Address: FLESHNER & KIM, LLP, P.O. Box 221200, Chantilly, VA, 20153-1200, US

(73) Assignee: LG Electronics Inc.

(21) Appl. No.: 10/338,756

(22) Filed: Jan. 9, 2003

(30) Foreign Application Priority Data
Jan. 10, 2002 (KR) 1494/2002

(51) Int. Cl. G02B 6/26; G02B 6/42; G02B 6/34

(52) U.S. Cl. 385/16; 385/31; 385/37

(57) ABSTRACT

Disclosed is an optical switch which increases a transmission rate without using a mechanical driving method and does not generate optical loss. To this end, in the optical switch, incident light beam from a plurality of input ports is propagated to a plurality of output ports as it is or the light beam is diffracted through a Bragg grating, and the diffracted light beam is propagated to the plurality of output ports.

### BACKGROUND OF THE INVENTION

1. Field of the Invention

The present invention relates to an optical switch, and more particularly, to an optical switch which uses Bragg diffraction.

2. Description of the Background Art

Recently, a research for transmitting a data fast is performed in accordance with that a demand for telecommunication information is increased.

In the meantime, an optical switch is a device which can transmit an optical signal having various information outputted from a plurality of optic fiber ports to an arbitrary port among the plurality of optic fiber ports spatially separated. Accordingly, the optic switch is an indispensable device in the optical telecommunication.

The optical switch is composed of two input ports and two output ports and a great capacity of the optical switch can be realized by arranging a plurality of optical switches properly.

Recently, a method for wavelength division multiplexing is spotlighted among the optical telecommunication methods. The method is a technique that a plurality of wavelengths are simultaneously transmitted through one optic fiber to improve a transmission rate of the data. At this time, an indispensable device in the wavelength division multiplexing method is a multiplexer having a function of adding and dropping, and a basic device of the multiplexer is ‘2×2’.

The method for realizing the ‘2×2’ optical switch according to the conventional art includes a method using a micro-electro-mechanical system (MEMS) technique and a method using an optical waveguide device. The former method is that a direction of an optical path is switched by controlling a movement of a mirror or bubble.

The method using the optical waveguide is that an optical waveguide to which light beam passes is fabricated on a plane substrate and a refractive index of the optical waveguide is changed to switch the direction of the optical path. The method includes a Mach-Zehnder interferometer method, a directional coupler method, and a X-optical waveguide method.

In the method using the MEMS technique which fabricates a mirror and changes an optical reflection angle, the mirror has to be driven mechanically, thereby lowering a reliability for a mechanical structure. Especially, the mirror driven by an input voltage is not controlled easily and accurately by a change of the driving angle.

Also, in the method using the optical waveguide, a length of the device becomes relatively long, so that a size of the optical switch becomes large in case of applying as a great capacity of a switch. Besides, optical loss is generated by a mode of an optical fiber and a mode mismatch of the waveguide.

As aforementioned, the optical switch according to the conventional art uses the mirror which requires a mechanical driving, thereby lowering an operation reliability for the mechanical structure.

Also, the optical switch according to the conventional art uses the optical waveguide, thereby having a large size of the apparatus and increasing the optical loss.

### SUMMARY OF THE INVENTION

Therefore, an object of the present invention is to provide an optical switch which increases a transmission rate without using a mechanical driving method and does not generate optical loss.

To this end, in the optical switch, incident light beam from a plurality of input ports is propagated to a plurality of output ports as it is or the light beam is diffracted through a Bragg grating, and the diffracted light beam is propagated to the plurality of output ports.

To achieve these and other advantages and in accordance with the purpose of the present invention, as embodied and broadly described herein, there is provided an optical switch comprising: a ferroelectric substance layer including a plurality of spontaneous polarization layers and a plurality of reversed polarization layers which the spontaneous polarization layers are domain-inverted; an electrode located at upper and lower surfaces of the ferroelectric substance layer for applying an electric field to the ferroelectric substance layer; an optical input port for making light beam incident on the ferroelectric substance layer with a predetermined angle; and an optical output port for propagating the light beam formed at the ferroelectric substance layer and diffracted through the Bragg grating or light beam which penetrated the ferroelectric substance layer as it is.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a perspective view of an optical switch utilizing Bragg diffraction according to the present invention;

FIG. 2 is a pattern diagram showing a state that light beam penetrates a ferroelectric substance layer when Bragg grating is not formed according to the present invention;

FIG. 3 is a pattern diagram showing an input/output relation of light beam in the ferroelectric substance layer where the Bragg grating is formed according to the present invention;

FIGS. 4A to 4C are flow charts showing a fabricating process of the ferroelectric substance layer which forms the Bragg grating and controls the formed Bragg grating in order to realize the optical switch according to the present invention;

FIGS. 5A to 5C are flow charts minutely showing a fabricating process of the ferroelectric substance layer which forms the Bragg grating and controls the formed Bragg grating in order to realize the optical switch according to the present invention;

FIG. 6 is a pattern diagram showing light beam propagation of the optical switch of a state that the Bragg grating is formed by applying a voltage to an electrode;

FIG. 7 is a distribution diagram of a refractive index generated at a sectional surface of A-A direction in FIG. 6;

FIG. 8 is a pattern diagram of light beam transmission of a case that a voltage is not applied to the electrode; and

FIG. 9 is a distribution diagram of a refractive index generated at a sectional surface of A-A′ direction in FIG. 8.

### DETAILED DESCRIPTION OF THE PREFERRED EMBODIMENTS

Reference will now be made in detail to the preferred embodiments of the present invention, examples of which are illustrated in the accompanying drawings.

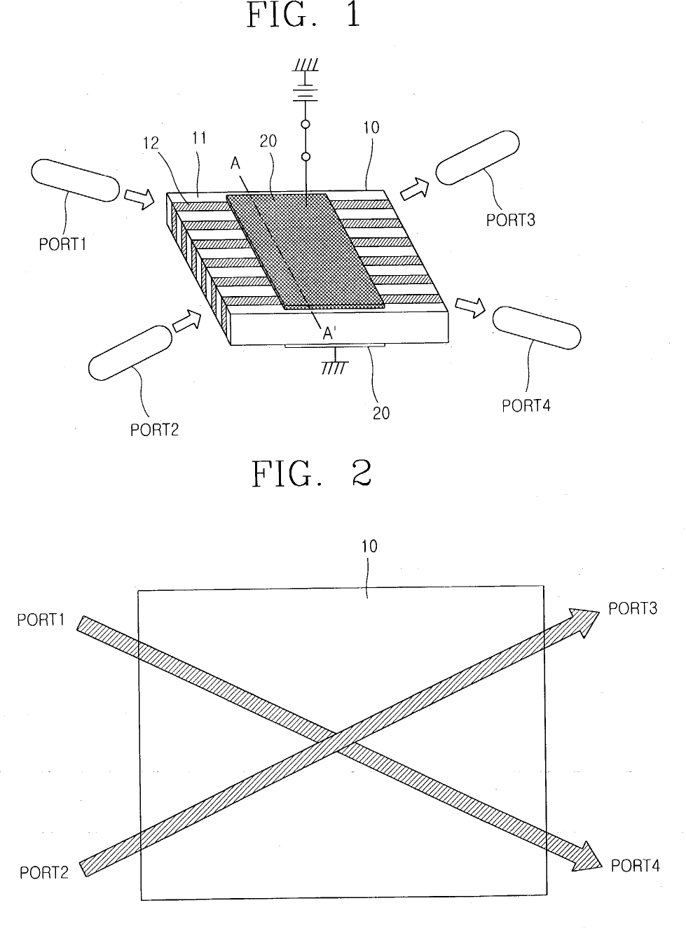

An optical switch which increases a transmission rate and does not generate optical loss by propagating incident light beam from the plurality of input ports to the plurality of output ports as it is or diffracting the incident light beam through the Bragg grating and by propagating the diffracted light beam to the plurality of output ports will be explained with reference to FIGS. 1 to 9.

FIG. 1 is a perspective view of an optical switch utilizing Bragg diffraction according to the present invention.

As shown, the optical switch according to the present invention comprises: a ferroelectric substance layer 10 including a plurality of spontaneous polarization layers 11 and a plurality of reversed polarization layers 12 located between the spontaneous polarization layers by alternating which the spontaneous polarization layers are domain-inverted; electrodes 20 located at upper and lower surfaces of the ferroelectric substance layer 10 for applying an electric field to the ferroelectric substance layer 10 to change a polarization direction of the ferroelectric substance layer 10; optical input ports 1 and 2 for makinglight beam (optical signal having various information) incident on the ferroelectric substance layer including the spontaneous polarization layers 11 and the reversed polarization layers 12 with a predetermined angle (a tilted direction); and optical output ports 3 and 4 for propagating the incident light beam through the optical input ports 1 and 2 according to a state of the ferroelectric substance layer 10. The spontaneous polarization is formed at the Curie temperature and the reversed spontaneous polarization is formed by applying an electric field to the spontaneous polarization. Herein, the polarization reversal indicates that a direction of the polarization which is spontaneously formed at first is forcibly rotated to a reverse direction, that is 180°, and fixed. Accordingly, a polarization direction of the spontaneous polarization layer 11 and that of the reversed polarization layer 12 are opposite each other.

Hereinafter, constructions of the optical switch according to the present invention and a fabricating method thereof will be explained with reference to the attached drawings.

FIG. 2 is a pattern diagram showing a state that light beam transmits a ferroelectric substance layer when Bragg grating is not formed according to the present invention.

As shown in FIG. 2, in case that the Bragg grating is not formed at the ferroelectric substance layer 10, incident light beam through the optical input port 1 passes the ferroelectric substance layer 10 and is applied to the optical output port 4. That is, the incident light beam through the optical input port 1 goes straight to penetrate the ferroelectric substance layer 10 as it is and is applied to the optical output port 4. Also, in case that the Bragg grating is not formed at the ferroelectric substance layer 10, incident light beam through the optical input port 2 passes the optical output port 3 and is propagated to the exterior. Herein, the optical input port 1 and the optical output port 4 are located in a diagonal direction on the basis of the ferroelectric substance layer 10. Also, the optical input port 2 and the optical output port 3 are located in a diagonal direction on the basis of the ferroelectric substance layer 10.

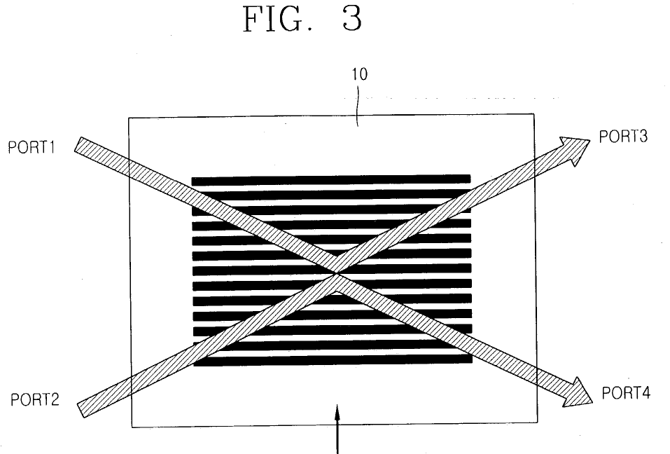

In the meantime, when a voltage is applied to the electrode 20 and an electric field is applied to the ferroelectric substance layer 10 by the electrode 20, the Bragg grating is formed at the ferroelectric substance layer 10. At this time, incident light beam to the ferroelectric substance layer 10 through the optical input ports 1 and 2 is diffracted by the Bragg grating and propagated to the ports 3 and 4 of a different direction. That is, the incident light beam to the ferroelectric substance layer 10 through the optical input port 1 is diffracted by the grating, and the diffracted light beam is applied to the optical output port 3. Also, the incident light beam to the ferroelectric substance layer 10 through the optical input port 2 is diffracted by the grating, and the diffracted light beam is applied to the optical output port 4. This will be explained with reference to FIG. 3.

FIG. 3 is a pattern diagram showing an input/output relation of light beam in the ferroelectric substance layer where the Bragg grating is formed according to the present invention.

As shown in FIG. 3, the incident light beam through the optical input port 1 is diffracted by the Bragg grating and reflected to the optical output port 3 located at the corresponding direction of the optical input port 1 not the diagonal direction. Also, the incident light beam through the optical input port 2 is diffracted by the Bragg grating and reflected to the optical output port 4 located at the corresponding direction of the optical input port 2 not the diagonal direction.

When the incident light beam meets the Bragg grating, the light beam is diffracted with an angle which is proportional to its own wavelength and inversely proportional to a period of the grating. Accordingly, input ports and output ports of the light beam are arranged at desired positions by using the Bragg grating, and the Bragg grating is formed at an optical path or extinguished, thereby fabricating the optical switch which can change the optical path fast, accurately, and easily by being used in optical communication, and etc.

Hereinafter, the structure of the optical switch according to the present invention which can control formation and extinguishment of the Bragg grating will be explained.

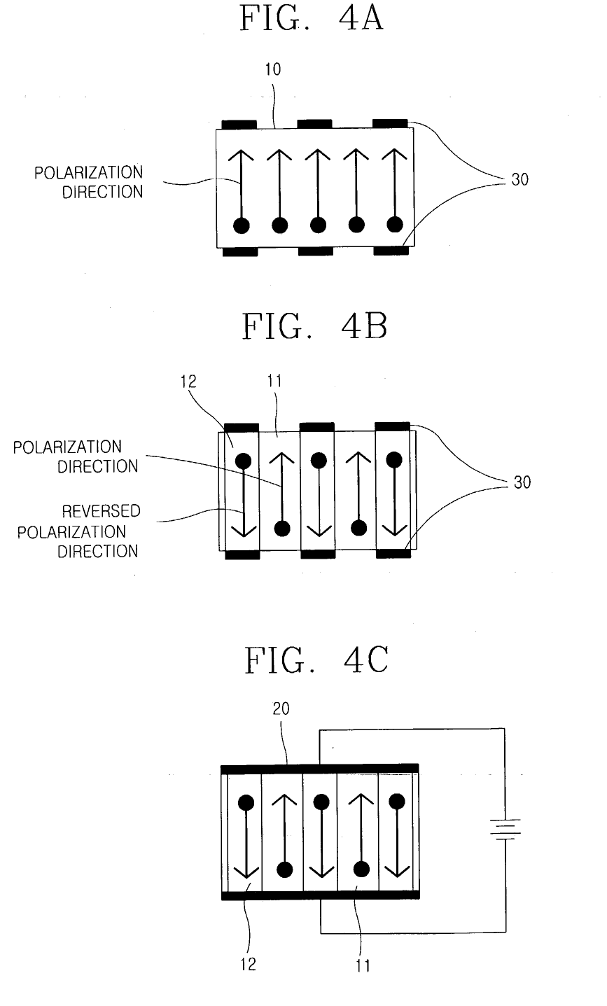

FIGS. 4A to 4C are flow charts showing a fabricating process of the ferroelectric substance layer which forms the Bragg grating and controls the formed Bragg grating in order to realize the optical switch according to the present invention.

At first, as shown in FIG. 4A, the ferroelectric substance layer 10 having the spontaneous polarization toward a constant direction is prepared, and a plurality of electrodes 30 are formed at upper and lower surfaces of the ferroelectric substance layer 10. At this time, each area of the plurality of electrodes 30 and blank area between the electrodes 30 are equal.

As shown in FIG. 4B, a voltage is applied to the plurality of electrodes 30 formed at the upper and lower surfaces of the ferroelectric substance layer 10. At this time, an electric field is formed at some regions of the ferroelectric substance layer 10 located between electrodes formed at the upper surface of the ferroelectric substance layer 10 and electrodes formed at the lower surface of the ferroelectric substance layer 10. When the electric field is applied to said some regions of the ferroelectric substance layer 10, the polarization direction of said some regions of the ferroelectric susbtance layer 10 is changed as a reverse direction. That is, the polarization direction of said some regions of the ferroelectric substance layer 10 is changed as 180°.

Accordingly, the spontaneous polarization layer 11 in which the spontaneous polarization is formed and the reversed polarization layer 12 that the spontaneous polarization is domain-inverted are formed. Herein, the spontaneous polarization layer 11 in which the spontaneous polarization is formed is different from the reversed polarization layer 12 that the spontaneous polarization is domain-inverted with 180°.

Then, as shown in FIG. 4C, the electrodes 30 are removed and electrodes 20 corresponding to the upper and lower surfaces of the spontaneous polarization layer 11 and the reversed polarization layer 12 are formed. At this time, the electrodes 20 are not located at each polarization layer 11 and 12 independently, but formed at the upper and lower surfaces of the ferroelectric substance layer 10.

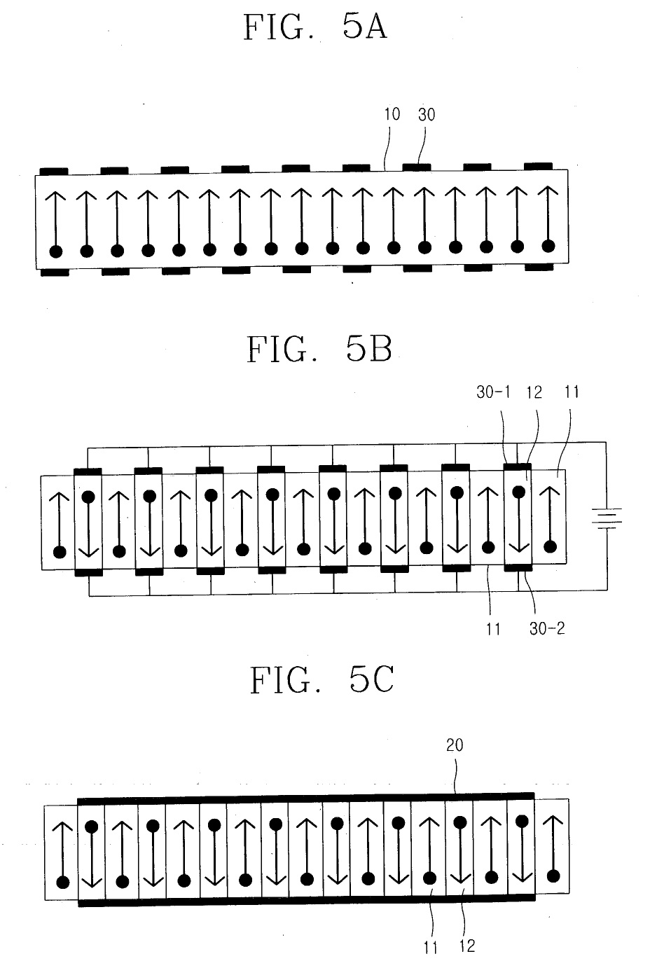

Hereinafter, a fabricating process of the ferroelectric substance layer 10 will be explained with reference to FIGS. 5A to 5C.

FIGS. 5A to 5C are flow charts minutely showing a fabricating process of the ferroelectric substance layer which forms the Bragg grating and controls the formed Bragg grating in order to realize the optical switch according to the present invention.

As shown in FIG. 5A, the ferroelectric substance layer 10 having the spontaneous polarization toward a constant direction is prepared, and a plurality of electrodes 30 are formed at upper and lower surfaces of the ferroelectric substance layer 10. The electrodes 30 formed at the upper and lower surfaces of the ferroelectric substance layer 10 are formed correspondingly to one another. At this time, each area of the plurality of electrodes 30 and blank area between the electrodes 30 are equal.

As shown in FIG. 5B, a voltage is applied to the plurality of electrodes 30 formed at the upper and lower surfaces of the ferroelectric substance layer 10. At this time, an electric field is applied to some regions (reversed polarization layer 12) of the ferroelectric substance layer 10 located between electrodes 30-1 formed at the upper surface of the ferroelectric substance layer 10 and electrodes 30-2 formed at the lower surface of the ferroelectric substance layer 10. That is, when the electric field is applied to said some regions of the ferroelectric substance layer 10, the polarization direction of said some regions of the ferroelectric substance layer 10 is changed as a reverse direction of that of the other regions (spontaneous polarization layer 11) of the ferroelectric substance layer 10 where the electrodes 30 are not formed. Accordingly, the spontaneous polarization layer 11 where the spontaneous polarization is formed and the reversed polarization layer 12 where the spontaneous polarization is domain-inverted are formed. Herein, the polarization direction of the spontaneous polarization layer 11 where the spontaneous polarization is formed and that of the reversed polarization layer 12 where the spontaneous polarization is domain-inverted is different as 180°.

Then, as shown in FIG. 5C, the electrodes 30 are removed and electrodes 20 are formed at the upper and lower surfaces of the ferroelectric substance layer 10 composed of the spontaneous polarization layers 11 and the reversed polarization layers 12 which are alternately located between the spontaneous polarization layers 11. That is, by the voltage applied to the electrodes 20, the polarization direction of the spontaneous polarization layer 11 and that of the reversed polarization layer 12 are changed to form the Bragg grating, and by the formed Bragg grating, incident light beam can be diffracted. Also, the incident light beam can be propagated to the optical output ports 3 and 4 through the ferroelectric substance layer 10 without diffraction by shielding the voltage applied to the electrodes 20 and thereby extinguishing the formed Bragg grating.

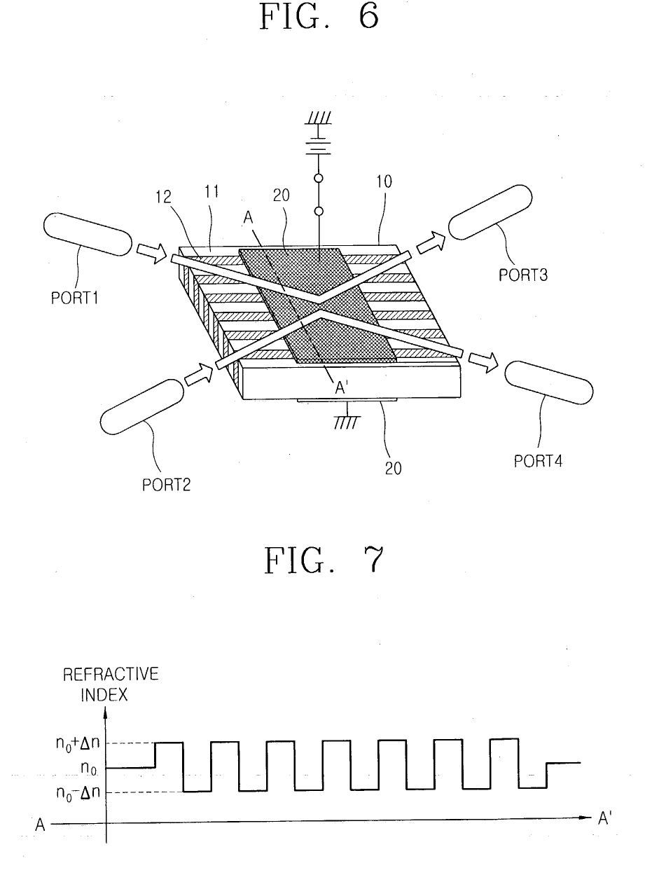

FIG. 6 is a pattern diagram showing light beam propagation of the optical switch of a state that the Bragg grating is formed by applying a voltage to an electrode, and FIG. 7 is a distribution diagram of a refractive index generated at a sectional surface of A-A′ direction in FIG. 6.

As shown in FIG. 6, when the voltage is applied to the electrodes 20, refractive indexes of the spontaneous polarization layer 11 and the reversed polarization layer 12 are shown as different directions. That is, when the voltage is applied to the electrodes 20, linear electro-optical effect is shown as a reverse direction in the spontaneous polarization layer 11 and the reversed polarization layer 12. Herein, the linear electro-optical effect indicates that the refractive index is linearly changed in proportion to an electric field.

When the voltage (electric field) is applied to the electrodes 20 in a state that the spontaneous polarization layer 11 and the reversed polarization layer 12 are alternately arranged periodically, the Bragg grating having a periodical refractive index distribution is formed. At this time, if light beam is made incident with a predetermined angle (except angles of 0° and 90°) for the ferroelectric substance layer 10 which the spontaneous polarization layer 11 and the reversed polarization layer 12 are all exposed, the incident light beam can be diffracted with the same angle as the incident angle of the light beam. At this time, factors which determine the diffractive angle of the light beam are inversely proportional to a period of the grating and proportional to a wavelength of the light beam, so that the diffractive angle of the light beam can be controlled by changing the period of the grating. Accordingly, the incident light beam through the optical input port 1 is diffracted with the same angle as the incident angle and propagated to the exterior by controlling the diffractive angle of the light beam, and the incident light beam through the optical input port 2 is propagated to the exterior through the optical output port 4.

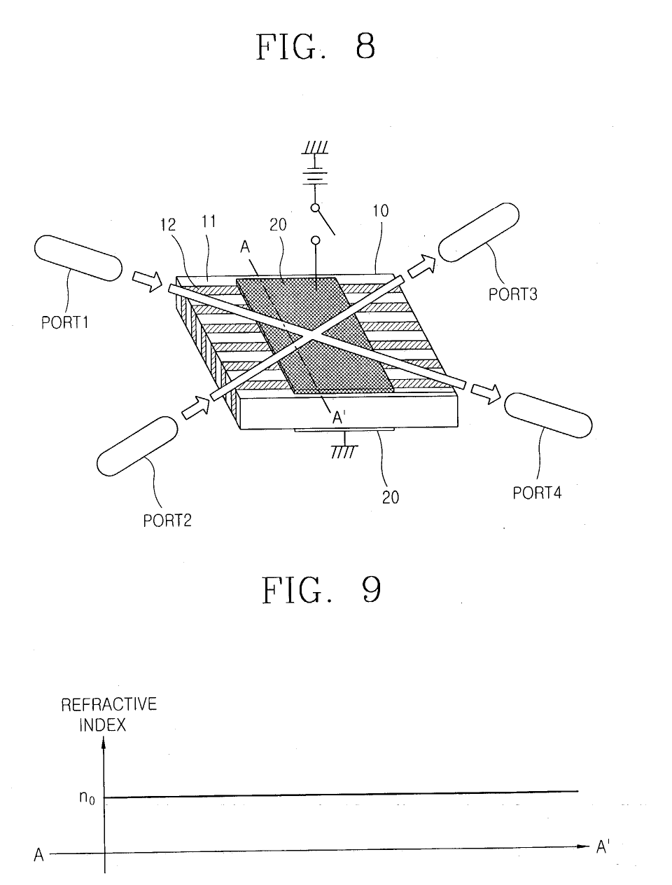

FIG. 8 is a pattern diagram of light beam transmission of a case that a voltage is not applied to the electrode, and FIG. 9 is a distribution diagram of a refractive index generated at a sectional surface of A-A′ direction in FIG. 8.

As shown in FIG. 8, when the voltage is not applied to the electrodes 20, the polarization directions of the spontaneous polarization layer 11 and the reversed polarization layer 12 which constitute the ferroelectric substance layer 10 are changed to the first polarization direction, and the refractive indexes of the spontaneous polarization layer 11 and the reversed polarization layer 12 are equal.

On the contrary, if the refractive indexes of the spontaneous polarization layer 11 and the reversed polarization layer 12 are not equal in a state that the voltage is not applied to the electrodes 20, the reason is because that a direction of an inner electric field generated by a default of the ferroelectric substance layer 10 is not aligned to the polarization direction and thereby the refractive index change amount by the inner electric field is different. In this case, the direction of the inner electric field has to be aligned to the polarization direction by a high temperature heat processing.

Hereinafter, the high temperature heat processing will be explained.

First, a temperature is slowly increased with a ratio less than 1° C./min from a normal temperature, and the high temperature state is maintained for several hours. Then, the high temperature is slowly lowered to the normal temperature with a ratio less than 1° C./min. At this time, the reason why the temperature is slowly changed with a ratio less than 1° C./min is in order to prevent electrostatic charge from being generated by pyroelectric effect in case of changing the temperature drastically.

Then, the high temperature heat processing is performed and the direction of the inner electric field is aligned to the polarization direction, so that the refractive index change amount generated by the inner electric field is equal. Therefore, the refractive index distribution of the spontaneous polarization layer 11 and the reversed polarization layer 12 are shown as FIG. 9. Like this, even if the gratings having polarization directions different as 180° are alternately and periodically located, the refractive index is not influenced. Accordingly, the incident light beam from the input port 1 is not diffractive and transmitted as it is, thereby being propagated to the exterior through the optical output port 4 oppositely located on the basis of the ferroelectric substance layer 10. Also, the incident light beam through the optical input port 2 is propagated to the exterior through the optical output port 3.

Then, in order not to cause reflection of the light beam, a surface of the ferroelectric substance layer 10 on which the light beam is made incident or propagated is polished, and a dielectric film is laminated on the polished surface to form a non-reflecting layer (optical input port and optical output port). That is, an optical signal can be propagated without loss of the incident light beam by forming the non-reflecting layer.

Accordingly, in the present invention, the electrodes are formed at the upper and lower surfaces of the ferroelectric substance layer 10 where the spontaneous polarization region and the reversed polarization region which the spontaneous polarization is domain-inverted are periodically and alternately located. Also, the voltage applied to the electrodes is controlled to control the Bragg grating, thereby changing the optical path as a desired direction. Herein, the method for controlling the Bragg grating in the ferroelectric substance layer 10 by forming the electric field includes a fast transmission rate, thereby fast changing the optical path at a desired time point. Also, the method does not have a construction having a mechanical driving, thereby increasing an operation reliability of the optical switch.

As aforementioned, in the optical switch according to the present invention, the electric field is applied to the ferroelectric substance layer where the spontaneous polarization region and the reversed polarization region which the spontaneous polarization is domain-inverted are periodically and alternately located, thereby fast changing the optical path.

Also, in the optical switch according to the present invention, by controlling the electric field applied to the ferroelectric substance layer where the spontaneous polarization region and the reversed polarization region which the spontaneous polarization is domain-inverted are periodically and alternately located, the optical path can be easily and accurately changed without a mechanical driving. That is, the operatoin reliability of the optical switch according to the present invention can be increased.

Also, in the optical switch according to the present invention, by controlling the electric field applied to the ferroelectric substance layer where the spontaneous polarization region and the reversed polarization region which the spontaneous polarization is domain-inverted are periodically and alternately located, optical loss by using an optical waveguide can be prevented.

Also, in the optical switch according to the present invention, by controlling the electric field applied to the ferroelectric substance layer where the spontaneous polarization region and the reversed polarization region which the spontaneous polarization is domain-inverted are periodically and alternately located, a transmission rate can be increased.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. An optical switch, which propagates incident light beam from a plurality of input ports to a plurality of output ports as it is or diffracts the light beam through a Bragg grating and propagates the diffracted light beam to a plurality of output ports.

2. The optical switch of claim 1, wherein the light beam is diffracted through the Bragg grating, or the light beam is transmitted as it is by extinguishing the Bragg grating.

3. The optical switch of claim 1, wherein the Bragg grating is generated or extinguished by an electric field.

4. The optical switch of claim 1, wherein the light beam is an optical signal having various information.

5. The optical switch of claim 1, wherein the plurality of input ports and the plurality of output ports are plural optic fiber ports.

6. The optical switch of claim 5, wherein the optical signal inputted from the plurality of optic fiber input ports is diffracted through the Bragg grating and propagated to an arbitrary port among the plurality of optic fiber output ports.

7. The optical switch of claim 1 comprising:
a ferroelectric substance layer including a plurality of spontaneous polarization regions and a plurlaity of reversed polarization regions which the spontaneous polarization are domain-inverted;
an electrode located at upper and lower surfaces of the ferroelectric substance layer for applying an electric field to the ferroelectric substance layer;
an optical input port for making the light beam incident on the ferroelectric susbtance layer with a predetermined angle; and
an optical output port for propagating the light beam formed at the ferroelectric substance layer and diffracted through the Bragg grating or light beam which penetrated the ferroelectric substance layer as it is.

8. The optical switch of claim 7, wherein the light beam is diffracted by the Bragg grating formed at the ferroelectric substance layer when an electric field is applied to the ferroelectric substance layer.

9. The optical switch of claim 7, wherein the light beam penetrates the ferroelectric substance layer as it is when the electric field is not applied to the ferroelectric substance layer.

10. The optical switch of claim 7, wherein the plural reversed polarization regions are located between the plurality of spontaneous polarization regions by periodically alternating.

11. The optical switch of claim 7, wherein the Bragg grating is formed or extinguished by an electric field applied through the electrode.

12. The optical switch of claim 7, wherein the optical input port makes the light beam incident on the ferroelectric substance layer with a predetermined angle.

13. The optical switch of claim 12, wherein the predetermined angle excludes 0° and 90°.

14. The optical switch of claim 7, wherein the optical input port and the optical output port are at least more than one.

15. An optical switch comprising:
a ferroelectric substance layer including a plurality of spontaneous polarization layers and a plurlaity of reversed polarization layers which the spontaneous polarization layers are domain-inverted;
an electrode located at upper and lower surfaces of the ferroelectric substance layer for applying an electric field to the ferroelectric substance layer and thereby for forming a Bragg grating in the ferroelectric substance layer;
an optical input port for making the light beam incident on the ferroelectric substance layer with a predetermined angle; and
an optical output port for propagating the light beam formed in the ferroelectric substance layer and diffracted by the Bragg grating or light beam which penetrated the ferroelectric substance layer as it is.

16. The optical switch of claim 15, wherein the Bragg grating is generated or extinguished by the electric field.

17. The optical switch of claim 15, wherein the plurality of reversed polarization regions are located between the plurality of spontaneous polarization regions by periodically alternating.

18. The optical switch of claim 15, wherein the predetermined angle excludes 0° and 90°.

19. The optical switch of claim 15, wherein the optical input port and the optical output port are at least more than one.

20. The optical switch of claim 15, wherein the spontaneous polarization layers and the reversed polarization layers are arranged by periodically alternating, herein the spontaneous polarization layers are some regions of a ferroelectric substance layer which are spontaneously polarized at a temperature more than Curie temperature and the reversed polarization layers are some regions of the ferroelectric substance layer which the spontaneous polarization layers are domain-inverted.

21. The optical switch of claim 15, wherein the ferroelectric substance layer diffracts incident light beam from the optical input terminal by the Bragg grating formed therein when the electric field is applied, propagates the diffracted light beam to a corresponding optical output port, and propagates incident light beam from the optical input port to a corresponding optical output port as it is when the electric field is not applied.
